(19) United States
(12) Patent Application Publication
(10) Pub. No.: US 2009/0095426 A1
(43) Pub. Date: Apr. 16, 2009

(54) TAPE STICKING APPARATUS, MOUNTING APPARATUS AND MOUNTING METHOD

(75) Inventor: Takahisa Yoshioka, Tokyo (JP)

Correspondence Address: LOWE HAUPTMAN HAM & BERNER, LLP, 1700 DIAGONAL ROAD, SUITE 300, ALEXANDRIA, VA, 22314, US

(73) Assignee: LINTEC CORPORATION, TOKYO (JP)

(21) Appl. No.: 12/093,106

(22) PCT Filed: Dec. 4, 2006
(86) PCT No.: PCT/JP2006/324160

§ 371 Date: May 8, 2008

(30) Foreign Application Priority Data
Dec. 9, 2005 (JP) 20058-355911

(51) Int. Cl. B32B 37/00

(52) U.S. Cl. 156/378; 156/64

(57) ABSTRACT

A raw sheet L, in which a strip-shaped tape base material TB having a die bonding sheet portion DS with a size of substantially corresponding to the shape of a semiconductor wafer W is temporarily stuck to a strip-shaped release liner S, is fed out, and the position of the die bonding sheet portion DS is identified on the pathway of feeding out. Based on the identified result, a die cutting device 13 provides a closed-loop-shaped cut-line C to be encircling the die bonding sheet portion DS corresponding to the shape of the ring frame RF to form a sticking tape DDT. The sticking tape DDT is peeled by a peeling device 15 to be stuck to the ring frame RF in the position that the die bonding sheet portion DS is to be corresponding to the semiconductor wafer W.

### FIELD OF THE INVENTION

The present invention relates to a tape sticking apparatus, a mounting apparatus and a mounting method, particularly to a tape sticking apparatus, a mounting apparatus and a mounting method suitable for unitizing a semiconductor wafer (hereinafter, simply referred to as “wafer”) and a ring frame by forming a sticking tape on the pathway of feeding out a raw sheet in which a tape base material having an adhesive sheet portion is temporarily stuck on one surface of a release liner to stick the sticking tape to the wafer and the ring frame.

### BACKGROUND OF THE ART

Conventionally, a wafer is disposed on the inside of a ring frame, and a dicing tape is stuck on their surfaces in advance of individuating a wafer on which circuit surfaces are formed, thereby fixing the wafer to the ring frame. As a dicing tape sticking procedure described above, such a following method is known that after a strip-shaped dicing tape is stuck to the ring frame and the wafer, the outside of the circumference of the dicing tape is cut off to correspond to the shape of the ring frame using a cutter (refer to, for example, patent document 1).

Patent Document 1: Japanese Patent Application Laid-Open No. 2003-257898

### SUMMARY OF THE INVENTION

### Problem to be Solved by the Invention

However the arrangement described in the patent document 1 is an apparatus for sticking the dicing tape and a die bonding sheet individually. And, after sticking the dicing tape, the outside of the circumference of the dicing tape is to be cut off corresponding to the shape of the ring frame using a cutter. Especially because positioning of the dicing tape is not performed, there is such a disadvantage that the arrangement is not adaptable when the position of the die bonding sheet portion needs to be identified as in the case of such a raw sheet in which the die bonding sheet portion substantially corresponding to the planar shape of the wafer is laminated on the surface of the dicing tape.

### OBJECT OF THE INVENTION

The present invention has been proposed in view of the above disadvantage, and the main object of the present invention is to provide an apparatus capable of sticking a dicing tape and a die bonding sheet in a lump to a ring frame and a plate-like member as an adherend even if an area to stick thereto is already formed in a part of the raw sheet, and further, to provide a tape sticking apparatus capable of identifying the corresponding position of the area so that a sticking tape, which is obtained by forming a cut-line corresponding to the identified position, can be stuck to the ring frame while the die bonding sheet can be stuck to the plate-like member precisely.

Additionally, another object of the present invention is to provide a mounting apparatus and a mounting method capable of unitizing a plate-like member and a ring frame using a sticking tape.

### Means for Solving the Problem

To achieve the above object, the present invention adopts such an arrangement, includes:

a feed-out device for feeding out a raw sheet in which a strip-shaped tape base material having an adhesive sheet portion with a size of substantially corresponding to the shape of a plate-like member is temporarily stuck on one surface of a strip-shaped release liner; a cutting device which is disposed on the pathway of feeding out the raw sheet, and is forming a closed-loop-shaped cut-line to be the same size as the adhesive sheet portion or to be larger by a predetermined amount than that on the tape base material to form a sticking tape; a peeling device for peeling the sticking tape from the release liner; a sticking device for sticking the sticking tape by relatively moving the plate-like member and the peeling device so that the adhesive sheet portion is substantially corresponding to the surface of the plate-like member; and a collecting device for collecting the raw sheet after peeling off of the sticking tape by the peeling device; wherein

a position detecting device for the adhesive sheet portion is disposed on the upstream side of the feeding out direction of the raw sheet with respect to the cutting device, and the position of the adhesive sheet portion is identified by the position detecting device and the cutting device is controlled to form the cut-line to be encircling the adhesive sheet portion.

Also, the present invention adopts such an arrangement that a mounting apparatus, in which a plate-like member is disposed on the inside of a ring frame for unitizing the ring frame and the plate-like member, comprising:

a feed-out device for feeding out a raw sheet in which a strip-shaped tape base material having an adhesive sheet portion with a size of substantially corresponding to the shape of a predetermined plate-like member is temporarily stuck on one surface of a strip-shaped release liner; a cutting device which is disposed on the pathway of feeding out the raw sheet, and is forming a closed-loop-shaped cut-line corresponding to the shape of the ring frame to be encircling the adhesive sheet portion on the tape base material to form a sticking tape; a peeling device for peeling the sticking tape from the release liner; a sticking device for sticking the sticking tape to the ring frame by relatively moving the plate-like member disposed on the inside of the ring frame and the peeling device so that the adhesive sheet portion is substantially corresponding to the surface of the plate-like member; and a collecting device for collecting the raw sheet after peeling off of the sticking tape by the peeling device; wherein

a position detecting device for the adhesive sheet portion is disposed on the upstream side of the feeding out direction of the raw sheet with respect to the cutting device, and the position of the adhesive sheet portion is identified by the position detecting device and the cutting device is controlled to form the cut-line to be encircling the adhesive sheet portion.

Further, the present invention adopts such an arrangement that a mounting method, for fixing a plate-like member to a ring frame by disposing the ring frame on a table, and disposing the plate-like member on the inside of the ring frame, and then sticking a sticking tape to the ring frame, comprising:

a process for feeding out a raw sheet in which a strip-shaped tape base material having an adhesive sheet portion with a size of substantially corresponding to the shape of the plate-like member is temporarily stuck on one surface of a strip-shaped release liner;

a position detecting process for identifying the position of the adhesive sheet portion on the pathway of feeding out the raw sheet;

a cutting process for forming a closed-loop-shaped cut-line to be encircling the adhesive sheet portion to form a sticking tape;

a process for peeling the sticking tape from the release liner, and for sticking it to the ring frame and the plate-like member; and a process for collecting the raw sheet after peeling off of the sticking tape; wherein

the position of the adhesive sheet portion is identified in the position detecting process and the cutting device is controlled to form the cut-line to be encircling the adhesive sheet portion.

According to the present invention, the dicing tape and the die bonding sheet can be stuck to the plate-like member and the ring frame in a lump. Also, the position of each adhesive sheet portion is identified by the position detecting device, and the position to form each cut-line is determined based on the identified result, and then a control is formed to form the cut-line by the cutting device, whereby the sticking tape can be stuck to the ring frame in a position corresponding to the position of the adhesive sheet portion being to be precisely stuck to the plate-like member.

Additionally, in the present invention, the “closed-loop” requires only a shape with no edge, therefore it includes also elliptical shapes, polygonal shapes, and the like, not only a shape closed in a circle.

### BRIEF DESCRIPTION OF THE DRAWINGS

FIG. 1 is a front view schematically showing a mounting apparatus in accordance with the embodiment.

FIG. 2A is a front view showing a raw sheet, FIG. 2B is a cross sectional view from the right showing the raw sheet, and FIG. 2C is a cross sectional view showing a condition of a sticking tape being stuck to a ring frame and a wafer.

FIG. 3 is a plan view schematically showing an essential part of a die cutting device.

FIG. 4 is a perspective view schematically showing the die cutting device.

FIG. 5 is a perspective view schematically showing a condition of the die cutting device in which frame boards are omitted.

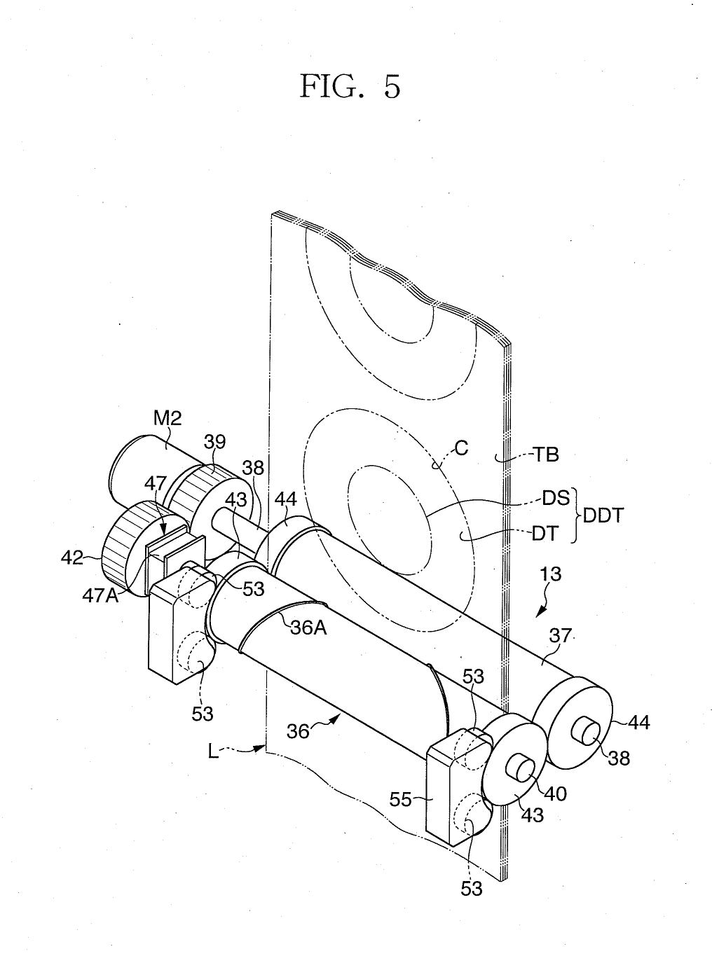

FIG. 6 is a front view schematically showing an alternative example similar to FIG. 1.

### EXPLANATION OF REFERENCE NUMERALS

10: mounting apparatus (tape sticking apparatus)
11: feed-out device
13: die cutting device (cutting device)
14: position detecting device
15: peeling device
16: sticking device
17: collecting device
C: cut-line
DS: die bonding sheet portion (adhesive sheet portion)
DT: dicing tape
DDT: sticking tape
L: raw sheet
RF: ring frame
S: release liner
TB: tape base material
W: semiconductor wafer (plate-like member)

### BEST MODE FOR CARRYING OUT THE INVENTION

Hereinafter, an embodiment of the present invention will be described with reference to the drawings.

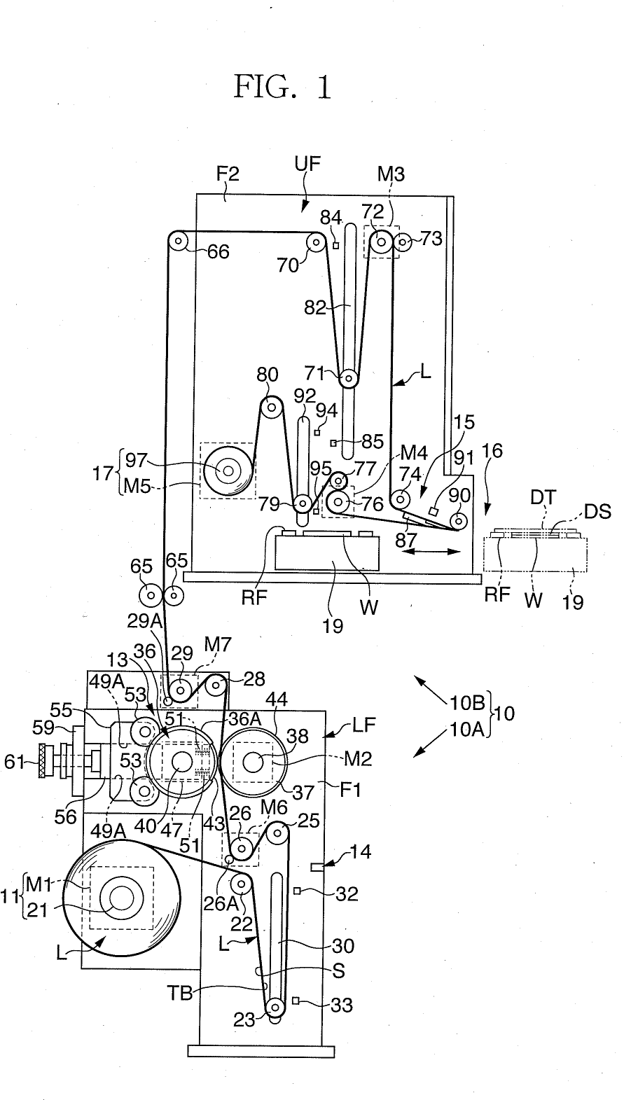

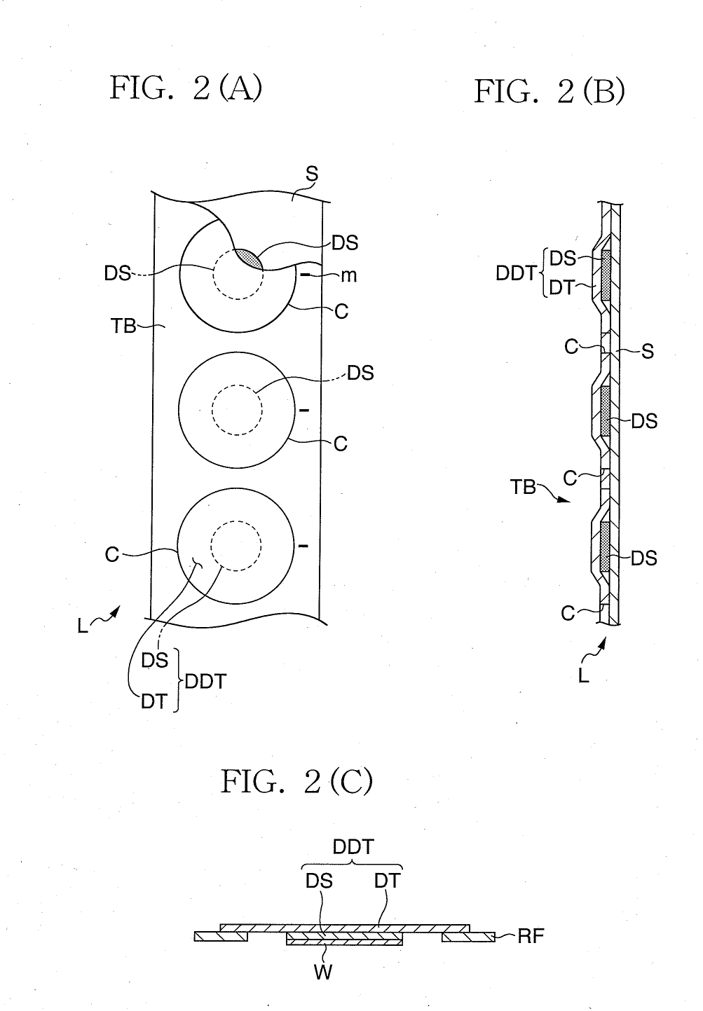

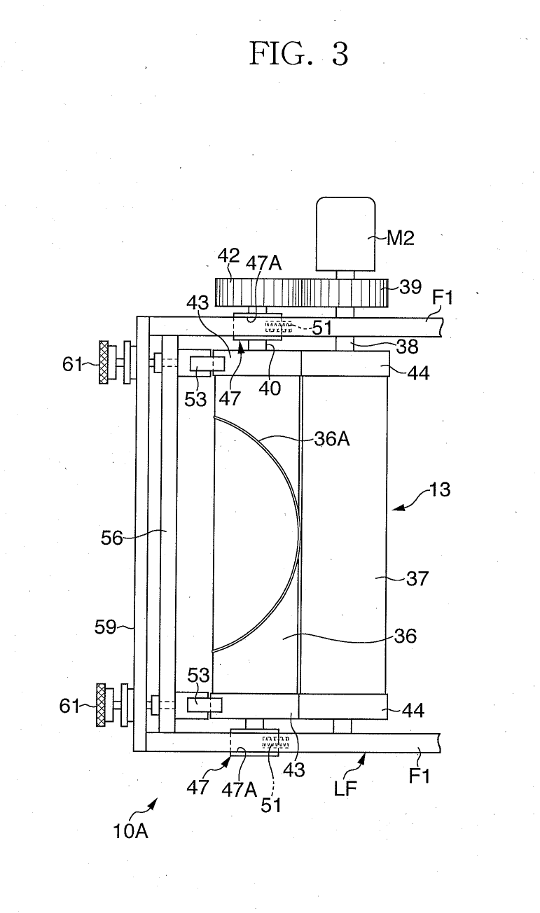

FIG. 1 shows a schematic front view of a mounting apparatus to which a tape sticking apparatus according to the embodiment is applied: FIG. 2A and FIG. 2B show a raw sheet which is used in the mounting apparatus; and FIG. 2C shows a cross sectional view of a dicing tape and a die bonding sheet portion being stuck to a ring frame and a wafer. In these drawings, the raw sheet L comprises a strip-shaped tape base material TB which includes the dicing tapes DT having the die bonding sheet portions DS as adhesive sheet portions, and is temporarily stuck on one surface of a strip-shaped release liner S. Each of the die bonding sheet portions DS is a heat sensitive adhesive sheet with a size of substantially corresponding to the shape of the wafer W as a plate-like member. A mounting apparatus 10 comprises a lower unit 10A and an upper unit 10B. The lower unit 10A comprises: a lower frame LF which includes a pair of frame boards F1 relatively disposed in the direction perpendicular to the paper surface in FIG. 1 (in the vertical direction in FIG. 3); a feed-out device 11 which is disposed within the lower frame LF area and is feeding out the raw sheet L; a die cutting device 13 as a cutting device which forms closed-loop-shaped cut-lines C (refer to FIG. 2A, FIG. 2B, and FIG. 3) on the tape base material TB, each corresponding to the shape of the ring frame RF located on the outside of the circumference of the wafer W, on the pathway of feeding out the raw sheet L to form the dicing tapes DT having the die bonding sheet portions DS (hereinafter, referred to as “sticking tape DDT”); and a position detecting device 14 which is disposed on the upstream side of the feeding out direction of the raw sheet L with respect to the die cutting device 13, and is identifying the position of each die bonding sheet portion DS.

The upper unit 10B comprises: an upper frame UF which includes frame boards F2; a peeling device 15 which is disposed within the upper frame UF area and is peeling the sticking tape DDT from the release liner S; a sticking device 16 for sticking the sticking tape DDT to the ring frame RF and the wafer W respectively; and a collecting device 17 which winds and collects the raw sheet L after peeling off of the sticking tape DDT by the peeling device 15. In the lower side of the peeling device 15, a table 19 is provided to be movable in the right and left directions in FIG. 1 and is containing a heating means for heating the die bonding sheet portion DS in the sticking tape DDT, then the ring frame RF and the wafer W are sucked and supported on the upper surface side of the table 19. In addition, each part of the devices in the lower unit 10A and the upper unit 10B is overall controlled through a control device (not shown).

The feed-out device 11 comprises a motor M1 and a support shaft 21 which is rotationally driven by the motor M1, and the raw sheet L being wound as a roll is supported around the support shaft 21. The raw sheet L fed out from the feed-out device 11 is to be fed out toward the downstream side, that is, toward the upper unit 10B side, through sequentially disposed a guide roll 22, a first dancer roll 23, a guide roll 25, and a feed-out roll 26, then the cut-lines C are formed by the die cutting device 13, and further fed out through a guide roll 28, and a feed-out roll 29, and then brought out to the upper unit 10B side. In this regard, the first dancer roll 23 is provided to be vertically movable along an upwardly and downwardly elongated slot 30 which is formed in the frame boards F1, and over-and-under control of the raw sheet L is performed according to an upper sensor 32 and a lower sensor 33 which are respectively located on the upper portion and the lower portion of the slot 30. And, the feed-out rolls 26 and 29 nip the raw sheet L with their respective nip rolls 26A and 29A, and the tension applying to the raw sheet L therebetween is controlled through their respective torque motors M6 and M7, and also positioning for feeding out is controlled according to the pulse signals from the motors, at the same time.

As shown in FIG. 3, the die cutting device 13, which is disposed between the frame boards F1 and F1, comprises: a die cutting roll 36 which is provided with a cutting blade 36A on the peripheral surface thereof; a platen 37 which is relatively disposed to the die cutting roll 36; a motor M2 which rotates the platen 37; a driving gear 39 which is fixed to a rotary shaft 38 of the platen 37; and a driven gear 42 which is fixed to a rotary shaft 40 of the die cutting roll 36 to be engaged with the driving gear 39. And, bearers 43 and 44 are respectively disposed at both sides of the die cutting roll 36 and the platen 37, whereby the die cutting roll 36 and the platen 37 can maintain a constant distance between their central axes, and consequently, cutting of the tape base material TB by the cutting blade 36A can be performed with a high degree of accuracy. In addition, the cutting blade 36A is to have a closed-loop circular shape with a slightly smaller diameter than that of the ring frame RF when the die cutting roll 36 rotates, and is formed at the level of forming the cut-line C on the tape base material TB.

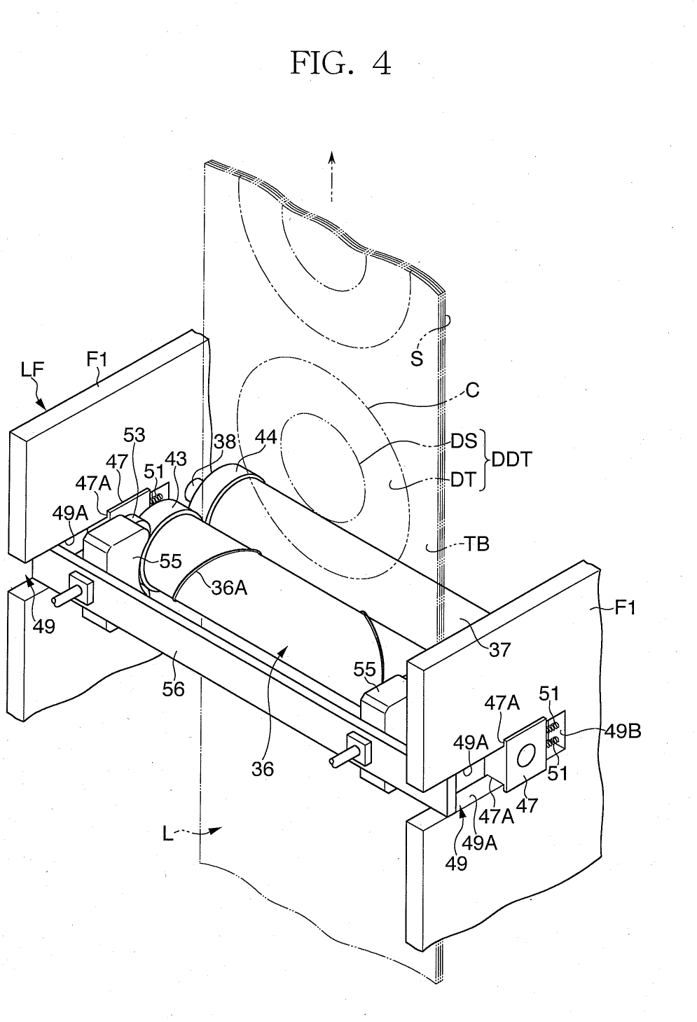

On both sides of the rotary shaft 40 of the die cutting roll 36, as shown in FIG. 4, slide blocks 47 having bearing function are provided, and these slide blocks 47 are disposed within substantially U-shaped cutout portions 49 formed in the surfaces of the frame boards F1. More specifically, each side-end surface of the slide block 47 is provided in a substantially H-shape, and the upper and the lower formational edges 49A of the cutout portion 49 are set in the upper and the lower grooves 47A respectively so that each slide block 47 is prevented from dropping off in the direction perpendicular to the surfaces of the frame boards F1. And, a spring member 51 is disposed between the slide block 47 and the bottom portion 49B of the U-shape in the cutout portion 49, whereby the die cutting roll 36 is biased toward the direction away from the platen 37 under the presence of the spring members 51.

As for the bearers 43, rollers 53 are disposed contacting with each two points, that is, the upper and the lower points, on the peripheral surface area on the other side of the corresponding bearers 44, respectively. These rollers 53 are provided to be rotatable through bearings 55, and these bearings 55 are connected mutually through a connecting board 56. The connecting board 56 is elongated between the cutout portions 49 formed on both sides of the frame boards F1 to be movable along the right and left directions in FIG. 1. And, the open-end side of the U-shape of each cutout portion 49 is blocked with a board-like member 59 which is elongated between the frame boards F1, and adjusting knobs 61 are provided at two points on the longitudinal direction of the board-like member 59 in order to move the surface position of the connecting board 56 in the right and left directions. In the embodiment, the connecting board 56 can be moved in the right direction in FIG. 1 by turning the adjusting knobs 61 clockwise direction, then the rollers 53 of the bearings 55 which are fixed on the connecting board 56 can move the die cutting roll 36 toward the platen 37 side against the biasing force of the spring members 51 through the bearers 43, so that the bearers 43 on the die cutting roll 36 side and the bearers 44 on the platen 37 side can be adjusted to contact mutually. On the other hand, the die cutting roll 36 can be moved away from the platen 37 with the biasing force of the spring members 51 by turning the adjusting knobs 61 counterclockwise direction.

The position detecting device 14 disposed on the upstream side of the feeding out direction of the raw sheet L with respect to the die cutting device 13 is, in the embodiment, provided in a position shortly before the guide roll 25. As for the position detecting device 14, for example, an optical sensor such as an optically transparent type sensor may be used. And, as shown in FIG. 2A, the position detecting device 14 identifies the position of each die bonding sheet portion DS by detecting each mark m which is printed at the same pitch as the pitch of the die bonding sheet portions DS, and determines the starting position of each cut-line C by converting from the pulse signals from the motor M6 which drives the feed-out roll 26 for feeding out the raw sheet L. Therefore, movement of the die cutting device 13 is controlled through the control device (not shown), and the platen 37 and the die cutting roll 36 which operates simultaneously with the platen 37 are rotationally driven according to each starting position of the cut-lines C. When each cut-line C is formed at the finish of one rotation, the platen 37 and the die cutting roll 36 are stopped their rotation and the raw sheet L is passed straight through without any processing to the next starting position of cutting.

The raw sheet L on which the cut-lines C are already formed in the lower unit 10A is to be fed out to the upper unit 10B through a pair of rolls, that is, a nip roll 65 and a guide roll 66, supported through a supporting device (not shown).

Through the upper unit 10B, a guide roll 70, a second dancer roll 71, a tension roll 72 and a pinch roll 73 which apply a predetermined tension to the raw sheet L by a torque adjustable motor M3, a guide roll 74, and a peeling device 15 are disposed inside the surfaces of the frame boards F2, then the sticking tape DDT is peeled off sequentially by the peeling device 15. Also, the raw sheet L after peeling off of each sticking tape DDT by the peeling device 15 is to be wound up by the collecting device 17 through a driving roll 76 which is driven by a motor M4, a nip roll 77, a third dancer roll 79, and a guide roll 80.

The second dancer roll 71 is provided to be movable along an upwardly and downwardly elongated slot 82 which is formed in the frame boards F2, and over-and-under control on the raw sheet L is performed according to an upper sensor 84 and a lower sensor 85 which are respectively located on the upper area and the lower area of the slot 82. Moreover, even when the operation stops in the upper unit 10B, the die cutting device 13 is not stopped in the middle of forming the cut-line C, and the dancer roll 71 absorbs the fed out amount. Therefore, a disadvantage that the cut-line C cannot be made continuously and precisely when stopping and rotating operations are performed in the middle of forming the cut-line C can be cleared away. The motor M3 biases the tension roll 72 toward the opposite direction from the feeding out direction so that the raw sheet L between the tension roll 72 and the driving roll 76 can remain a predetermined tension.

The peeling device 15 comprises, in the embodiment, a peel plate 87, with which the sticking tape DDT can be peeled off from the raw sheet L by sharply folding back against the feeding out direction of the raw sheet L at the edge position of the peel plate 87, then the sticking tape DDT is stuck on the upper surfaces of the ring frame RF and the wafer W on the table 19 which moves according to the timing of the peeling operation. In this regard, a press roll 90 which forms the sticking device is disposed on the edge side of the peel plate 87. The press roll 90 applies a predetermined pressure to the sticking tape DDT, which is already peeled, to stick it on the surfaces of the ring frame RF and the wafer W. In addition, a sensor 91 is disposed on the near side of the press roll 90 (the upstream side of the feeding out direction of the raw sheet L), and each mark m is detected by the sensor 91, and then movement timing coordination of the table 19 is performed, whereby the sticking tape DDT is stuck to the ring frame RF, thus the die bonding sheet portions DS is to be stuck to the wafer W in a substantially corresponding condition.

The third dancer roll 79 is provided to be movable along an upwardly and downwardly elongated slot 92 which is formed in the frame boards F2, and winding control on the collecting device 17 is performed according to an upper sensor 94 and a lower sensor 95 which are respectively located on the upper portion and the lower portion of the slot 92. The collecting device 17 comprises a motor M5 and a winding shaft 97 which is linked with the motor M5.

Next, an overall operation of the mounting apparatus 10 according to the embodiment will be described.

As for the initial operation, pull out the raw sheet L from the feed-out device 11 and, as shown in FIG. 1, fix the leading edge of the raw sheet L to the winding shaft 97 of the collecting device 17. On the other hand, put the ring frame RF and the wafer W on the upper surface of the table 19 to be sucked, and put them on standby in the position shown in the full line in FIG. 1.

According to the operation start signal, the control device overall controls each part of the devices in each of the upper and lower units 10A and 10B. That is, when the motors M1 to M7 start driving and feeding out with the raw sheet L is activated, the first to the third dancer rolls 23, 71 and 79 move upward and downward to maintain a constant tension on the raw sheet L while performing the feeding out operation of the raw sheet L. And, in the process of feeding out, the position detecting device 14 detects each mark m and determines the starting position to form each cut-line C, then based on the starting point, the die cutting device 13 forms the cut-line C on the tape base material TB to be encircling each die bonding sheet portion DS, thereby forming the sticking tapes DDT in the raw sheet L.

And when the mark m is detected by the sensor 91 provided near the peel plate 87, the table 19 starts moving toward the right side in FIG. 1 according to the predetermined timing, and then the sticking tapes DDT which is peeled off sequentially at the edge position of the peel plate 87 is fed out on the ring frame RF and the wafer to be stuck thereto by the press roll 90.

Therefore, according to the embodiment as described above, such effects are obtained that the cut-lines C can be formed to be encircling the die bonding sheet portion DS to form the sticking tape DDT, further, the sticking tape DDT can be stuck to the ring frame RF in a condition of the die bonding sheet portion DS being corresponding to the wafer W.

The best arrangement, method and the like for carrying out the present invention have been disclosed so far. However, the present invention is not limited to the above.

That is, the present invention has been illustrated and described mainly about a specific embodiment. However, it is possible for those skilled in the art to add various modifications, if necessary, to the above-described embodiment with respect to the shape, material, quantity and/or other detailed setup without departing from the technical spirit and the range of the object of the present invention.

Accordingly, it is to be understood that the descriptions limited in the shape and the like disclosed above are meant to be merely illustrative and explanatory to facilitate understanding the present invention and not restrictive of the invention. Therefore, descriptions by names of the elements by removing a part or all of the limitations such as about the shape shall be included in the present invention.

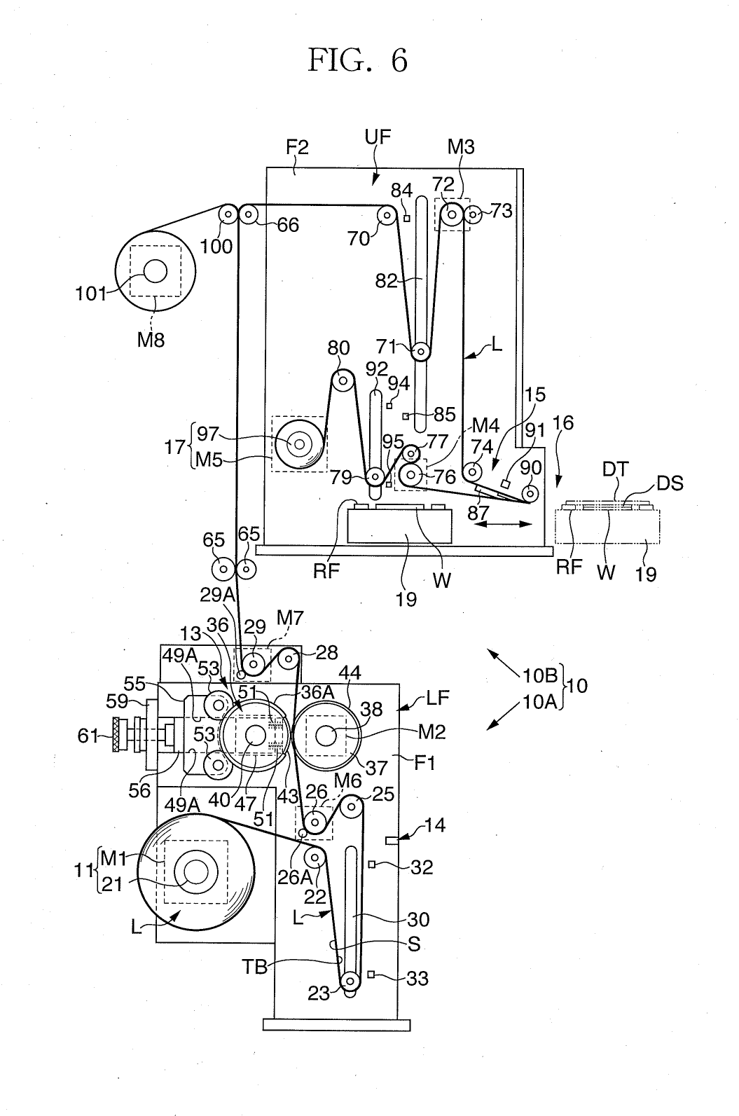

For example, in the above embodiment, such an arrangement is adopted that the raw sheet L to be collected by the collecting device 17 includes the release liner S and the unnecessary tape portion in the tape base material TB after peeling off the sticking tape DDT. However, the present invention is not limited to the above. For example, as shown in FIG. 6, by providing a pinch roll 100 which is in abutting contact with a guide roll 66, and a winding device 101 which is capable of rotating by a motor M8, the area outside of the cut-lines C in the tape base material TB, that is, the unnecessary tape portion resulting from forming of the cut-lines C, may be collected on the pathway of feeding out. Accordingly, the raw sheet L after passing through the winding device 101 is to be fed out toward the peeling device 15 side in the condition only the sticking tapes DDT are provided on one surface of the release liner S, and only release liner S is to be wound and collected by the collecting device 17.

Further, although an example in which the present invention is applied to the mounting apparatus for forming the sticking tape DDT from the raw sheet L to stick it to the ring frame RF and the wafer W has been illustrated and described, the present invention is not limited to the above. The present invention may be generally applied also to other tape sticking apparatus for other adherends, such as a compact disc (CD), a digital versatile disc (DVD), panels for display and glass.

Furthermore, in the embodiment, the mounting apparatus 10 is made up as a two-unit structure with the lower unit 10A and the upper unit 10B. However, the units 10A and 10B may be provided also as a laterally parallel structure, or may be made up as a single unit. Additionally, in the case of making up the units by each separate unit as the embodiment, versatility to be capable of decoupling the units for using them as each independent unit is given.

Still further, in the embodiment, the die cutting device 13 is adopted as the cutting device to form the cut-lines C on the tape base material TB. However, also other devices may be adopted to form the cut-lines C using a rotary blade along the surface of the tape base material TB.

What is claimed is:

1. A tape sticking apparatus, comprising: a feed-out device for feeding out a raw sheet in which a strip-shaped tape base material having an adhesive sheet portion with a size of substantially corresponding to the shape of a plate-like member is temporarily stuck on one surface of a strip-shaped release liner; a cutting device which is disposed on the pathway of feeding out the raw sheet, and is forming a closed-loop-shaped cut-line to be the same size as the adhesive sheet portion or to be larger by a predetermined amount than that on the tape base material to form a sticking tape; a peeling device for peeling the sticking tape from the release liner; a sticking device for sticking the sticking tape by relatively moving the plate-like member and the peeling device so that the adhesive sheet portion is substantially corresponding to the surface of the plate-like member; and a collecting device for collecting the raw sheet after peeling off of the sticking tape by the peeling device; wherein
a position detecting device for the adhesive sheet portion is disposed on the upstream side of the feeding out direction of the raw sheet with respect to the cutting device, and the position of the adhesive sheet portion is identified by the position detecting device and the cutting device is controlled to form the cut-line to be encircling the adhesive sheet portion.

2. A mounting apparatus in which a plate-like member is disposed on the inside of a ring frame for unitizing the ring frame and the plate-like member, comprising: a feed-out device for feeding out a raw sheet in which a strip-shaped tape base material having an adhesive sheet portion with a size of substantially corresponding to the shape of a predetermined plate-like member is temporarily stuck on one surface of a strip-shaped release liner; a cutting device which is disposed on the pathway of feeding out the raw sheet, and is forming a closed-loop-shaped cut-line corresponding to the shape of the ring frame to be encircling the adhesive sheet portion on the tape base material to form a sticking tape; a peeling device for peeling the sticking tape from the release liner; a sticking device for sticking the sticking tape to the ring frame by relatively moving the plate-like member disposed on the inside of the ring frame and the peeling device so that the adhesive sheet portion is substantially corresponding to the surface of the plate-like member; and a collecting device for collecting the raw sheet after peeling off of the sticking tape by the peeling device; wherein
a position detecting device for the adhesive sheet portion is disposed on the upstream side of the feeding out direction of the raw sheet with respect to the cutting device, and the position of the adhesive sheet portion is identified by the position detecting device and the cutting device is controlled to form the cut-line to be encircling the adhesive sheet portion.

3. A mounting method, for fixing a plate-like member to a ring frame by disposing the ring frame on a table, and disposing the plate-like member on the inside of the ring frame, and then sticking a sticking tape to the ring frame, comprising:
a process for feeding out a raw sheet in which a strip-shaped tape base material having an adhesive sheet portion with a size of substantially corresponding to the shape of the plate-like member is temporarily stuck on one surface of a strip-shaped release liner;
a position detecting process for identifying the position of the adhesive sheet portion on the pathway of feeding out the raw sheet;
a cutting process for forming a closed-loop-shaped cut-line to be encircling the adhesive sheet portion to form a sticking tape;
a process for peeling the sticking tape from the release liner, and for sticking it to the ring frame and the plate-like member; and
a process for collecting the raw sheet after peeling off of the sticking tape; wherein
the position of the adhesive sheet portion is identified in the position detecting process and the cutting device is controlled to form the cut-line to be encircling the adhesive sheet portion.
